(19) United States
(12) Patent Application Publication
(10) Pub. No.: US 2023/0206626 A1
(43) Pub. Date: Jun. 29, 2023

(54) PLANT DISEASE AND PEST CONTROL METHOD USING SPECTRAL REMOTE SENSING AND ARTIFICIAL INTELLIGENCE

(71) Applicants: Chinsu Lin, Chiayi City 600355 (TW); Wei-Min Liu, Chiayi County 621301 (TW); Keng-Hao Liu, Kaohsiung City 80424 (TW)

(72) Inventors: Chinsu Lin, Chiayi City 600355 (TW); Wei-Min Liu, Chiayi County 621301 (TW); Keng-Hao Liu, Kaohsiung City 80424 (TW)

(21) Appl. No.: 17/680,172

(22) Filed: Feb. 24, 2022

(30) Foreign Application Priority Data
Dec. 29, 2021 (TW) 110149410

(51) Int. Cl. G06V 20/10; G06T 7/10; G06V 20/70; G06V 10/58; G06T 17/20; G06V 20/17; G06T 7/00; A01G 7/06

(52) U.S. Cl. CPC G06V 20/188; G06T 7/10; G06V 20/70; G06V 10/58; G06T 17/20; G06V 20/17; G06T 7/0002; A01G 7/06; G06T 2207/10032; G06T 2207/30188

(57) ABSTRACT

Disclosed herein is a plant disease and pest control method using aerial photography and spectral remote sensing technology to record and analyze crop orthographic images. After building meshes from a dense point cloud or 3D depth map, orthographic images are generated. Then, the numbers of crop pest insect, crop leaf infestation area, and the ratio between leaf and its farmland area are calculated using deep learning techniques. After that, the growth curve of the pest population is established via modeling techniques and a pest and disease prediction model is established to determine the optimized timing for pesticide spraying.

### FIELD OF THE INVENTION

The present disclosure relates to a plant disease and pest control method using spectral remote sensing and artificial intelligence.

### BACKGROUND OF THE INVENTION

Currently, harvesting of most of high-cost crops is time sensitive. In today's environment with escalating labor cost and production cost, efficient planting and cultivation techniques have become more popular. Among these, aerial camera drones can be applied to inventory of crops, agricultural disaster damage analysis, species distribution and the like.

An aerial camera drone combines a remotely-controlled unmanned vehicle with flying capability and a photographic equipment. By flying to heights that are traditionally out of reach, it is able to obtain better views and images.

Existing aerial camera drones are capable of automatic positioning, route arrangement and spraying of fertilizers, but they lack the capabilities of image processing and data analysis. As a result, these aerial camera drones fail to maximize their effectiveness in crop cultivation and management.

Moreover, one of the main challenges facing cultivation of high-cost crops is infestations of diseases and pests. A common approach to this involves spraying and irrigating specific pesticides, However, restricted by limited manpower and vast plantation areas, it is often difficult to accurately evaluate the required doses of pesticides and areas. Among them, accurate determination of when pesticides should be applied is critical.

The main purpose of spraying pesticides is to eliminate or inhibit the growth of pests or diseases. If a pesticide is applied too late, the effect of control can be poor. On the other hand, if the pesticide is sprayed too early, it may affect the growth of the crops. The growth of diseases and pests in a farmland area are usually exponential. If the condition of the damage caused by a disease or pest cannot be obtained immediately, the farmer may miss the optimum time for administering a pesticide.

Furthermore, pest and disease attack is sometimes clustered or unevenly distributed. Therefore, if the distribution of a pest or disease in a large area of crops is not known, then the pesticide cannot be accurately applied. In the end, the farmer may resort to an even spread of the pesticide that may not be effective in eradicating the pest or disease, or an overdose of the pesticide in unaffected areas.

Therefore, the present disclosure provides a method for determining the optimized timing for pesticide spraying by combining aerial camera technology, spectral imaging sensing and artificial intelligent algorithms to improve the control and prevention of crop pests and diseases.

### SUMMARY OF THE INVENTION

In the specification, terms “a”, “an” and “one” are used for describing an element or component of the present invention. These terms are used for illustrative purposes and for providing a basic concept of the present invention. Further, these descriptions should be construed as including one or at least one. Unless the context states clearly otherwise, the singular forms should also include the plural referents. When used in conjunction with the terms “include”, “comprise” and their derivatives, the term “one” may refer to one or more.

The present disclosure discloses a plant disease and pest control method, which comprises the following steps of: providing orthographic images of a plurality of spectral image files of a collection of crop leaves and establishing an image data set of the crop leaves; building polygon meshes of the image files using a dense point cloud or 3D depth map; collecting spectral reflectance of a range of spectral colors from the spectral image files to establish a spectral feature analysis; calculating the area of crop leaves and the total number of pixels of the crop leaves based on the orthographic images; determining an infestation map of the crop leaves and the total number of pixels of infested crop leaves using a hyperspectral image detection algorithm or a machine learning technique; dividing the total number of pixels of the infested crop leaves by the total number of pixels of the crop leaves to determine an infested area of the crop leaves; and collecting insects using pest glue traps and determining the number of insects by analyzing the pest glue traps using an objection detection technique.

In an embodiment of the plant disease and pest control method described in the present disclosure, the orthographic images of the spectral image files are obtained using an aerial camera drone.

Another embodiment of the plant disease and pest control method described in the present disclosure further comprises establishing a pest and disease prediction model using a deep learning technique to estimate the size of a pest population and devise pest and disease control measures.

As shown in FIG. 1, the pest and disease prediction model established using a deep learning technique performs the obtaining of the orthographic images and the calculations of the infested area of the crop leaves described in the above plant disease and pest control method every hour, every day, every week or on a fixed unit time basis to establish a relationship diagram of the growth of a particular pest or disease to the accumulated infested area of a particular type of crop leaf. Thereafter, the optimized timing for pesticide application is determined based on the size of the pest population estimated from the pest glue traps.

In still another embodiment of the plant disease and pest control method described in the present disclosure, the crops include, but are not limited to, lotus leaves, mangoes, pumpkins, and lychees.

In yet another embodiment of the plant disease and pest control method described in the present disclosure, the pests and diseases include, but are not limited to, prodenia litura larvae, cabbage leaf moth larvae, small leaf moths, scale insects, gall gnats, thrips, oriental fruit flies, pumpkin flies, and lychee stink bugs.

Another embodiment of the present disclosure further comprises a method for calculating the total number of insects, which comprises the following steps of: providing orthographic images of a plurality of spectral image files of a collection of crop leaves and establishing an image data set of the crop leaves; building meshes from the image files using a dense point cloud or 3D depth map; collecting spectral reflectance of a range of spectral colors from the spectral image files to establish a spectral feature analysis; and estimating the size of a crop pest population using pest glue trap images.

### BRIEF DESCRIPTION OF THE DRAWINGS

FIG. 1 is a flowchart illustrating the overall technique in accordance with the present disclosure;

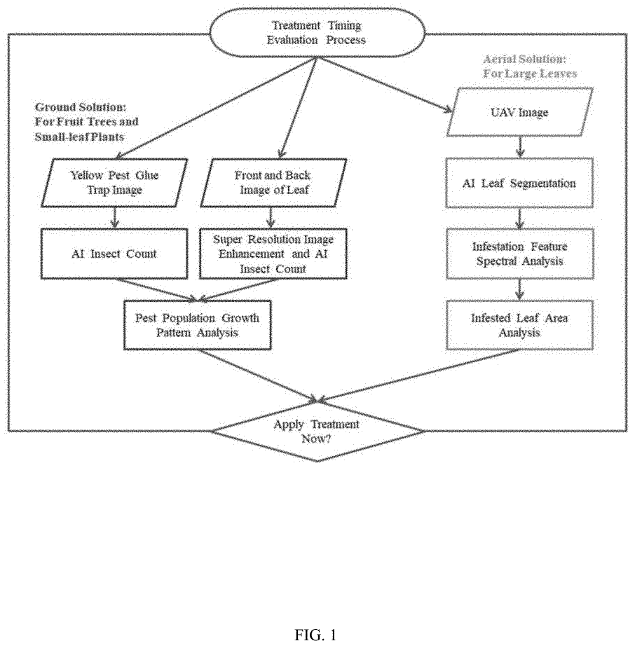

FIG. 2 is a graph illustrating a prediction model of small yellow thrips population and prediction of the timing of damage prevention;

FIG. 3 shows the detection and the calculation of small yellow thrips from the back of a leaf; and

FIG. 4 shows the detection and the calculation of small yellow thrips from a yellow pest glue trap in the field.

### DETAILED DESCRIPTION OF THE EMBODIMENTS

Prediction Model of Small Yellow Thrips

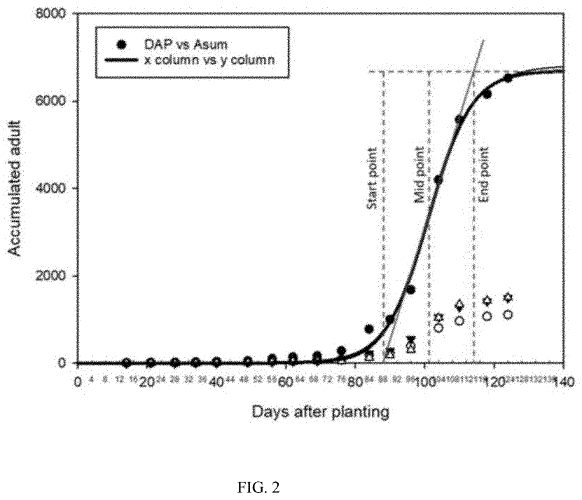

As shown in FIG. 2, x axis denotes time and y axis denotes the accumulated infested area of lotus leaves. Through deep learning based semantic segmentation model, the ratio of the area of lotus leaves in a lotus field and the ratio of the pest infestation area are detected to evaluate the growth of the lotuses. Then, a pest and disease prediction model is established using a single day as the unit.

As shown in FIG. 2, the number of small yellow thrips started to multiply on the 88^{th} day after planting the lotuses and the growth was exponential and reached its peak on the 115^{th} day of planting.

As calculated using the regression model shown in FIG. 2, the recommended optimized timing for pesticide application is one to two days before the exponential growth of the small yellow thrips. Thus, pesticide was applied on the 98^{th} day after planting in the control group. The number of small yellow thrips after treatment was a quarter of that in the case where no pesticide was used.

Detection and Calculation of Small Yellow Thrips on Back of Lotus Leaves

After increasing the resolution of out-of-focused areas using a super resolution network, the number of small yellow thrips on lotus leaves is calculated using a deep learning based object detection model.

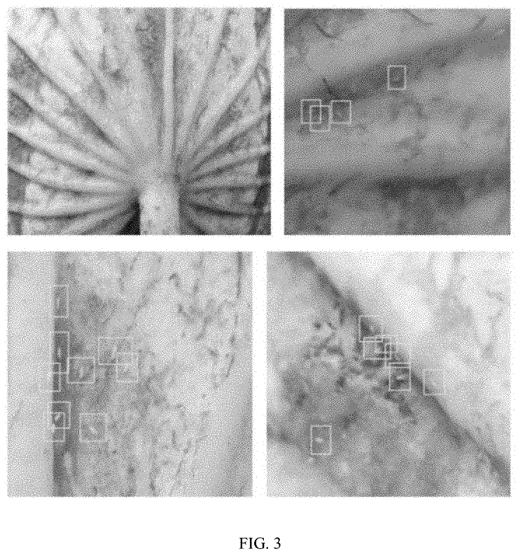

As shown in FIG. 3, an image of a whole leave is first segmented into several partial images and insects are detected using a trained deep learning model. The detection results are then combined to determine the total number of insects. The detection rate of the detection model used for small yellow thrips on the back of lotus leaves could be as high as 96.14%.

Detection and Calculation of Small Yellow Thrips from Yellow Pest Glue Traps in the Field

The numbers of small yellow thrips on yellow pest glue traps are detected and calculated using deep learning based objection detection models to estimate the size of the pest population.

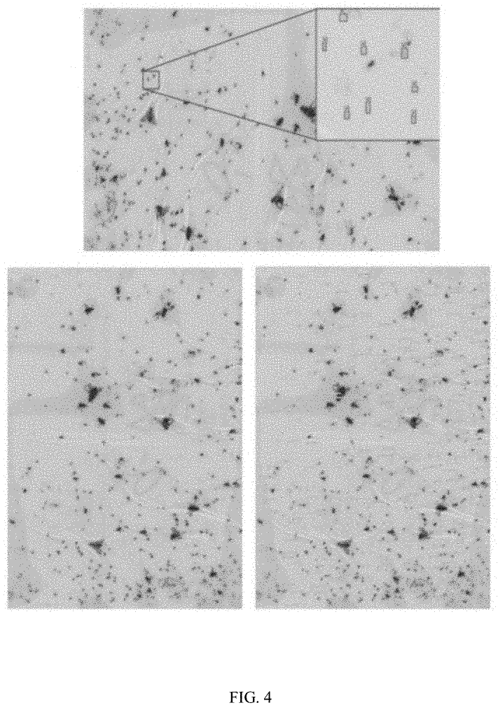

As shown in FIG. 4, the detection rates of small yellow thrips on yellow pest glue traps in the field under different deep learning models could reach between 89.99% and 93.34%.

What is claimed is:

1. A plant disease and pest control method comprising the following steps of:
(a) providing orthographic images of a plurality of spectral image files of a collection of crop leaves and establishing an image data set of the crop leaves;
(b) building polygon meshes of the image files using a dense point cloud or 3D depth map;
(c) collecting spectral reflectance of a range of spectral colors from the spectral image files to establish a spectral feature analysis;
(d) calculating the area of the crop leaves and the total number of pixels of the crop leaves based the orthographic images;
(e) determining an infestation map of the crop leaves and the total number of pixels of infested crop leaves using a hyperspectral image detection algorithm or a machine learning technique;
(f) calculating the area of crop leaves and the total number of pixels of the crop leaves from the orthographic images; and
(g) dividing the total number of pixels of the infested crop leaves by the total number of pixels of the crop leaves to determine an infested area of the crop leaves.

2. The plant disease and pest control method described of claim 1, further comprising establishing a pest and disease prediction model using a deep learning based semantic segmentation model to estimate the size of a pest population and devise pest and disease control measures.

3. The plant disease and pest control method described of claim 1, wherein the orthographic images of the plurality of spectral image files are obtained using an aerial camera drone.

4. The plant disease and pest control method described of claim 1, wherein the crops include, but are not limited to, lotus leaves, mangoes, pumpkins, and lychees.

5. The plant disease and pest control method described of claim 1, wherein the pests and diseases include, but are not limited to, prodenia litura larvae, cabbage leaf moth larvae, small leaf moths, scale insects, gall gnats, thrips, oriental fruit flies, pumpkin flies, and lychee stink bugs.

6. A method for determining the size and growth of an insect population comprising the following steps of:
(a) hanging several sheets of pest glue traps such that they are spread out evenly in the field;
(b) periodically retrieving and taking high resolution photos of the glue traps; and
(c) detecting the insects and determining the total number of the insects using a customized deep learning based objection detection model.

7. The method for determining the size and growth of an insect population of claim 6, further comprising establishing a pest and disease prediction model using a deep learning based object detection model to estimate the size of a pest population and pest and disease control timing.
